(19) United States
(12) Patent Application Publication
(10) Pub. No.: US 2021/0146754 A1
(43) Pub. Date: May 20, 2021

(54) METHOD FOR RESETTING A DEVICE, AND DEVICE AND CONTROL UNIT

(71) Applicant: TRUMA GERÄTETECHNIK GMBH & CO. KG, Putzbrunn (DE)

(72) Inventors: Mihai-Robert DÖMÖTÖR, Putzbrunn (DE); Franz FICHTNER, Putzbrunn (DE); Ulrich HÖFLINGER, Putzbrunn (DE)

(21) Appl. No.: 17/051,849

(22) PCT Filed: Apr. 9, 2019
(86) PCT No.: PCT/EP2019/058928

§ 371 Date: Oct. 30, 2020

(30) Foreign Application Priority Data
May 2, 2018 (DE) 10 2018 003 525.6

(51) Int. Cl. B60H 1/00; B60R 25/23; G05B 19/042

(52) U.S. Cl. CPC B60H 1/00971; B60R 25/23; G05B 2219/2614; B60H 1/00364; G05B 19/0428

(57) ABSTRACT

The invention relates to a method of resetting a device (2). The device (2) transmits an error signal (99) to a control unit (1). The control unit (1) outputs an acknowledgment signal (100). In response thereto, the device (2) outputs an inquiry signal (101). Based on the inquiry signal (101) received and a password, a reply signal (102) is generated by the control unit (1). Based on the reply signal (102), an information of the inquiry signal (101) and a password, the device generates a comparison result based on which a reset mechanism in the device (2) is activated. The invention further relates to a device (2) and a control unit (1).

The present invention relates to a method of resetting a device. The invention further relates to a corresponding device and a control unit.

Within the scope of progression in digitization, different devices can be controlled by a central unit in production plants, in houses or, e.g., also in travel trailers. To this end, wireless or wire-bound communication standards are known, which may be designed to be unidirectional or bidirectional.

When control commands are transmitted to the devices, it is known, for example, that an authentication takes place first. This is relevant in particular if the associated network is larger or extends over a larger area. For example, WO 2014/047384 A2 describes a communication between a central unit and so-called smart home devices. The devices include security modules that verify the identity of the central unit for access to the device. Methods of verifying the identity of field devices or measuring devices within networks are described, for example, in DE 10 2014 112 611 A1 or in DE 10 2012 217 743 A1.

When an error or an unusual condition occurs in a modern device, the device will signal the error to the control unit. When the error has been removed or the indicated condition is assessed e.g. by a user as being tolerable, some devices require that the error be acknowledged and the device be reset to a faultless condition. The resetting may also consist in emptying an error memory. A method of resetting a measuring device that is connected to a computer is disclosed, for example, in US 2017/0205790 A1.

If the device involved is, for example, a heater for a travel trailer, it is generally common in the prior art that the device has to be reset directly by direct contact with the device. In the case of installed devices, this may be quite awkward for the user.

The object of the invention is therefore to simplify the resetting of a device.

The object is achieved by the invention according to a first teaching involving a method of resetting a device. According to a further teaching, the object is achieved according to the invention by a device. A third teaching involves achieving the object according to the invention by a control unit. Finally, the object is achieved by a system having at least one device and a control unit.

One advantage of the invention is that it is reliably prevented that a device is reset by a non-approved unit, e.g. after the occurrence of an error. In one configuration, in particular a digital resetting of an error—in one configuration for example a safety-critical error—in a networked system is involved.

The invention achieves the object by a method of resetting a device, wherein an error signal is transmitted by the device to a control unit; the error signal is received by the control unit; an acknowledgment signal is output by the control unit; the acknowledgment signal is received by the device; an inquiry signal is output by the device in response to the acknowledgment signal received; the inquiry signal is received by the control unit; after a reception of the inquiry signal, a reply signal is generated and output by the control unit based on the inquiry signal received and based on a password stored in the control unit; the reply signal is received by the device; a comparison result is generated by the device based on the reply signal received, based on an information of the inquiry signal, and based on a password stored in the device; and a reset mechanism is activated in the device based on the comparison result.

According to the invention, at least the following steps take place when resetting the device:

The device transmits an error signal to a control unit. Thus, an error condition or, in general terms, an exceptional condition exists in the device, which is signaled by the device to a control unit by means of the error signal. The control unit is the component from which the device receives signals and to which the device sends signals. The device receives an acknowledgment signal. Whether the device follows this acknowledgment signal with a reset mechanism depends on the next steps. In response to the acknowledgment signal received, the device outputs an inquiry signal. The device in turn expects a suitable reply signal in response to the inquiry signal. When the device receives a reply signal, the device generates a comparison result from the reply signal received, from an information contained in the inquiry signal, and from a password that is stored in the device and is therefore known to the device. The device evaluates, as it were, the reply signal received by the device to determine whether it corresponds to the reply signal which the device had expected and which would therefore be the appropriate reply signal to the inquiry signal. Depending on the comparison result, the device carries out a reset mechanism or not. The reset mechanism consists, e.g., in an emptying of an error memory or in executing a function of the device or, e.g., in a starting of the device. The aforementioned reply signal is generated based on the inquiry signal and a password. The reply signal generated in response to the inquiry signal therefore depends on the reliable reception of the inquiry signal and on the password.

One configuration provides that the procedure according to the invention involving the exchange of signals between the device and the control unit takes place upon each occurrence of an error.

One advantage of the invention is given in particular if a plurality of devices (e.g., terminal devices) are connected to a control unit outputting the acknowledgment signals. The devices can then, by applying the method according to the invention, check back, so to speak, whether they have been addressed in any particular case.

According to the invention, this prevents an automatic and/or unintentional error reset from taking place, since the reset is only carried out after a successful authentication.

Moreover, the method allows a reset without direct contact with the device.

Finally, the invention allows protection against the use of non-authorized or, e.g., counterfeit devices and/or control units.

According to one configuration of the method, the password stored in the control unit and the password stored in the device are compared with one another during a coordination phase. This configuration is to ensure that the device and the associated control unit use the same password for securing the reset. The coordination phase here is, for example, part of the production or is initially activated after the device and the control unit are connected for the first time.

According to one configuration of the method, the comparison result is generated such that the comparison result provides information about whether the password used for generating the reply signal and the password stored in the device are identical. The evaluation of the reply signal in this configuration thus comes down to the question whether the respectively used passwords are identical.

One configuration of the method resides in that the inquiry signal is generated such that the inquiry signal contains as information a random character string generated by the device. In this configuration, the inquiry signal in each case contains a different information in the form of the random character string. The character string has an arbitrary length and may consist, e.g., only of a value or a number. In one configuration the random character string is a numerical value within a specified interval.

According to one configuration of the method, the reply signal is generated by a control unit in that an information of the inquiry signal received and the password stored in the control unit are linked to each other by a logic instruction stored in the control unit, and when the comparison result is generated, the information of the inquiry signal and the password stored in the device are linked to each other by a logic instruction stored in the device. In this configuration it is provided that a specific logic instruction is used for generating the reply signal and that when the comparison result is generated, a logic instruction is also used, which is thus the logic instruction that is expected. The logic instruction is e.g. the formation of a mathematical function (e.g., a hash function) from an information of the inquiry signal and the password. In one configuration the information and the password are linked with each other e.g. by an AND function or an OR function. The logic instruction thus dictates how the information and the password are to be processed in order to arrive at the reply signal.

One configuration of the method consists in that during a coordination phase, the logic instruction stored in the control unit and the logic instruction stored in the device are compared with each other. In this configuration it is provided that the control unit and the device are made acquainted with each other in a coordination phase. This is provided e.g. as a result of connecting the device to the control unit or is effected already at the factory during the production of the device and/or the control unit.

One configuration of the method consists in that the acknowledgment signal is output as a result of a command generated by a user. In this configuration, it is provided that a user intervention, e.g. by actuating a pushbutton on the control unit, is required in order to trigger the acknowledgment signal.

According to one configuration of the method, a time interval between the output of the inquiry signal and the reception of the reply signal is determined, and the comparison result is generated as a function of the time interval determined. In this configuration, it is monitored how fast the reply signal is received after the inquiry signal. In one configuration, the reset mechanism is not activated if a limit value for the time interval is exceeded.

One configuration of the method resides in that the acknowledgment signal is transmitted to the device each time after an error signal is transmitted by the device to a control unit and after a command generated by a user is received, and in that in the event that a number of error signals exceeds a predefined limit value or is equal to a predefined limit value within a predefined period of time, a supplementary user action is demanded. In this configuration, it is determined how often the device is reset within a certain period of time. If the number exceeds a limit value or is equal to such a limit value, a supplementary user action is required, i.e., in addition to entering the command that triggers the acknowledgment signal. Too frequent an acknowledging may be indicative of the device being too faulty, so that the pure acknowledging and resetting is not sufficient, or that the same error is always only acknowledged but continues to exist, so that the user should deal with the device and the error more thoroughly.

According to one configuration of the method, the supplementary user action consists in that the user waits a time period before enabling the reception of a further command and/or that the user acts directly on the device. In one configuration, the user is therefore forced to wait a certain amount of time before he can give another command to reset the device. In an alternative or additional configuration, the user is required to interact directly with the device, rather than operating it only remotely via the control unit.

According to a further teaching, the invention achieves the object by a device having an interface for sending and receiving signals, wherein the device outputs error signals via the interface, wherein, in the event that the device receives an acknowledgment signal via the interface, the device outputs an inquiry signal via the interface, receives a reply signal via the interface, generates a comparison result based on the reply signal received, based on an information of the inquiry signal, and based on a password stored in the device, and activates a reset mechanism in the device based on the comparison result.

The device is configured such that after receiving an acknowledgment signal, it makes sure by an inquiry signal whether the device is permitted to follow the acknowledgment signal by means of a reset mechanism. In one configuration, the acknowledgment signal is required here if the device has indicated the presence of an error or an unusual condition by means of an error signal.

In one configuration, the device according to the invention is embodied such that it can implement at least one of the aforementioned or following configurations of the method or can cooperate with the control unit described.

The device is configured to heat and/or cool a gas mixture and/or a liquid so that the device preferably fulfills functions of a heater and/or a boiler and/or an air conditioning system. In one configuration, the device is part of a travel trailer, a motorhome, or a ship.

The invention achieves the object according to a further teaching by a control unit having an interface for sending and receiving signals and having an input device for receiving a command generated by a user, wherein, in the event that the control unit receives a command from the user via the input device, the control unit outputs an acknowledgment signal via the interface, and wherein, in the event that the control unit receives an inquiry signal via the interface, the control unit generates a reply signal based on the inquiry signal received and based on a password stored in the control unit and outputs the reply signal via the interface.

The control unit is configured such that after sending an acknowledgment signal to a device, it causes an authentication to be performed in that the control unit generates an appropriate reply signal after receiving an inquiry signal. The reply signal is obtained here based on an information of the inquiry signal and a password stored in the control unit. In this way, the reply signal provides information about whether the inquiry signal has been received correctly by the control unit and whether the control unit has the correct password.

In one configuration, the control unit according to the invention is embodied such that it can implement at least one of the configurations of the method that are described or can cooperate with the device described.

The control unit outputs parameter values via the interface in regard to a heating and/or a cooling of a gas mixture and/or a liquid. The control unit is configured to control at least one device in a travel trailer, a motorhome or a ship with respect to the temperature or the climate.

Finally, the invention achieves the object by a system which includes at least one device according to any of the above configurations and a control unit according to any of the above configurations.

In one configuration, the system is part of a travel trailer, a motorhome, a vehicle or a ship.

In detail, there is a multitude of options to configure and further develop the method according to the invention, the device according to the invention and the control unit according to the invention. In this regard, reference is made, on the one hand, to the claims dependent on claims 1, 12 and 14 and, on the other hand, to the description below of exemplary embodiments in conjunction with the drawings, in which:

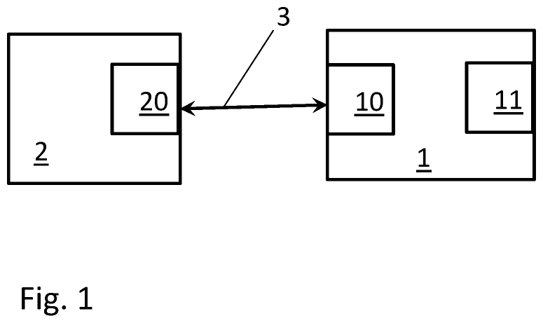

FIG. 1 shows a schematic representation of a system including a device and a control unit, and

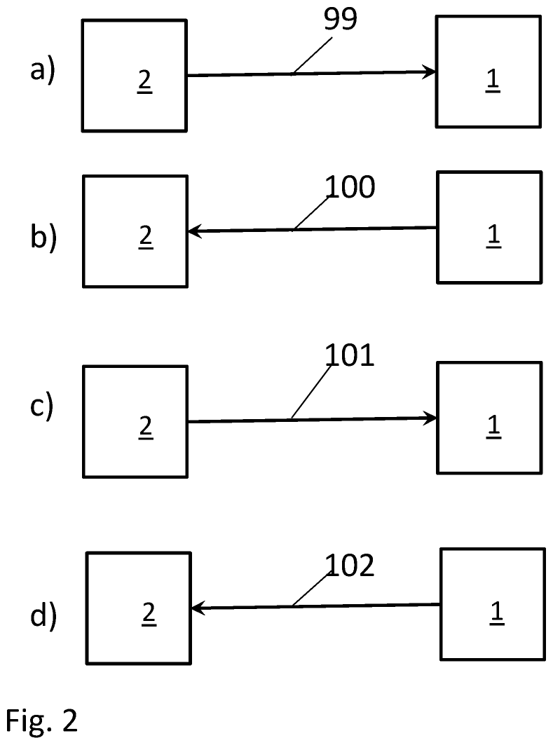

FIGS. 2a) to d) show a schematic representation of an exemplary process of resetting the device.

FIG. 1 shows a system that includes a control unit 1 and a device 2, which here are connected to each other via a bidirectional data line 3. The system is part of a travel trailer, a motorhome or a ship, for example.

The device 2, which is for example a heater and/or a boiler for heating water, has an interface 20 by means of which the device 2 receives and transmits signals.

The control unit 1 also includes an interface 10 for transmitting and receiving signals. Further provided is an input device 11 (e.g. a human-machine interface), via which a user can acknowledge the occurrence of an error in the device 2 and thus initiate the reset process.

The sequence of resetting the device 2 is indicated in FIG. 2. The device 2 and the control unit 1 are shown in a simplified form here. The time flow is from FIG. 2a) to FIG. 2d).

In FIG. 2a), the device 2 detects that an unusual condition exists, so that it is necessary to output an error signal 99 and, for example, to initiate a reaction, e.g. stopping a heating process.

The error signal 99 reaches the control unit 1 and is displayed there, for example visually. When a user enters an appropriate command at the control unit 1, the control unit 1 outputs an acknowledgment signal 100 to the device 2 (see FIG. 2b)).

In consequence of receiving this acknowledgment signal 100, the device 2 checks, by sending an inquiry signal 101 to the control unit 1, whether it is to start a reset mechanism (see FIG. 2c)).

In response to the inquiry signal 101, the control unit 1 generates a reply signal 102, which carries an information of the inquiry signal 101 and a password. As illustrated in FIG. 2d), the control unit 1 sends the reply signal 102 to the device 2.

The device 2 evaluates the reply signal 102 and, depending on a comparison result, activates a reset mechanism.

The device 2 generates the comparison result as a function of the information contained in the inquiry signal 101 sent by the device 2, as a function of the password stored in the device 2, and as a function of the reply signal 102. A positive comparison result means that the device 2 and the control unit 1 each have used the same password, that the inquiry signal 101 has been reliably received by the control unit 1, and that the device 2 and the control unit 1 access the same link instruction. Generally, by the comparison result it is queried whether the control unit 1 is really authorized to reset the device 2. The resetting causes the device to continue to function normally.

### LIST OF REFERENCE NUMBERS

1 control unit
2 device
3 data line
10 interface of the control unit
11 input device of the control unit
20 interface of the device
99 error signal
100 acknowledgment signal
101 inquiry signal
102 reply signal

1. A method of resetting a device (2),
wherein an error signal (99) is transmitted by the device (2) to a control unit (1);
the error signal (99) is received by the control unit (1);
an acknowledgment signal (100) is output by the control unit (1);
the acknowledgment signal (100) is received by the device (2);
an inquiry signal (101) is output by the device (2) in response to the acknowledgment signal (100) received;
the inquiry signal (101) is received by the control unit (1);
a reply signal (102) is generated and output by the control unit (1) based on the inquiry signal (101) received and based on a password stored in the control unit (1);
the reply signal (102) is received by the device (2);
a comparison result is generated by the device (2) based on the reply signal (102) received, based on an information of the inquiry signal (101), and based on a password stored in the device (2); and
a reset mechanism is activated in the device (2) based on the comparison result.

2. The method according to claim 1,
wherein the comparison result is generated such that the comparison result provides information as to whether the password used for generating the reply signal (102) and the password stored in the device (2) are identical.

3. The method according to claim 1,
wherein the inquiry signal (101) is generated such that the inquiry signal (101) contains as an information a random character string generated by the device (2).

4. The method according to claim 1,
wherein the reply signal (102) is generated in that an information of the inquiry signal (101) received and the password stored in the control unit (1) are linked to each other by a logic instruction stored in the control unit (1); and
wherein, when the comparison result is generated, the information of the inquiry signal (101) and the password stored in the device (2) are linked to each other by a logic instruction stored in the device (2).

5. The method according to claim 1,
wherein the acknowledgment signal (100) is output as a result of a command generated by a user.

6. The method according to claim 5,
wherein the acknowledgment signal (100) is transmitted to the device (2) each time after an error signal (99) is transmitted by the device (2) to a control unit (1) and after a command generated by a user is received; and
wherein in the event that a number of error signals (99) exceeds a predefined limit value or is equal to a predefined limit value within a predefined period of time, a supplementary user action is demanded.

7. The method according to claim 6,
wherein the supplementary user action consists in that the user waits a time period before enabling the reception of a further command and/or that the user acts directly on the device (2).

8. A device (2) comprising an interface (20) for sending and receiving signals,
wherein the device (2) outputs error signals (99) via the interface (20);
wherein, in the event that the device (2) receives an acknowledgment signal (100) via the interface (20), the device (2) outputs an inquiry signal (101) via the interface (20), receives a reply signal (102) via the interface (20), generates a comparison result based on the reply signal (102) received, based on an information of the inquiry signal (101), and based on a password stored in the device (2), and activates a reset mechanism in the device (2) based on the comparison result; and
wherein the device (2) is configured to heat and/or cool a gas mixture and/or a liquid so that the device (2) fulfills functions of a heater and/or a boiler and/or an air conditioning system.

9. A control unit (1) comprising an interface (10) for sending and receiving signals and comprising an input device (11) for receiving a command generated by a user,
wherein, in the event that the control unit (1) receives a command from the user via the input device (11), the control unit (1) outputs an acknowledgment signal (100) via the interface (10);
wherein, in the event that the control unit (1) receives an inquiry signal (101) via the interface (10), the control unit (1) generates a reply signal (102) based on the inquiry signal (101) received and based on a password stored in the control unit (1) and outputs the reply signal via the interface (10); and
wherein the control unit (1) is configured to control a device (2) in a travel trailer, a motorhome or a ship with respect to a temperature and/or a climate in that the control unit (1) outputs parameter values via the interface (10) in regard to a heating and/or a cooling of a gas mixture and/or a liquid.
